(19) United States
(12) Patent Application Publication
(10) Pub. No.: US 2022/0155714 A1
(43) Pub. Date: May 19, 2022

(54) IMAGE FORMING DEVICE

(71) Applicant: Konica Minolta, Inc., Tokyo (JP)

(72) Inventors: Munenori NAKANO, Toyokawa-shi Aichi (JP); Soh HIROTA, Toyokawa-shi Aichi (JP); Yoshinori TSUTSUMI, Toyokawa-shi Aichi (JP)

(21) Appl. No.: 17/529,436

(22) Filed: Nov. 18, 2021

(30) Foreign Application Priority Data
Nov. 18, 2020 (JP) 2020-191328

(51) Int. Cl. G03G 15/00; G03G 15/01

(52) U.S. Cl. CPC G03G 15/5041; G03G 15/5062; G03G 15/556; G03G 15/0131

(57) ABSTRACT

An image forming device including a forming unit, an adhesion amount detector, a correction coefficient determiner, and a correction unit. The forming unit forms line images each having a different line width. The adhesion amount detector detects a toner adhesion amount for each of the line images. The correction coefficient determiner determines, according to the toner adhesion amounts detected for each line width, correction coefficients for a gradation value of the line images of each line width. The correction unit corrects a gradation value of a line image using a correction coefficient corresponding to the line width of the line image when forming the line image.

### CROSS REFERENCE TO RELATED APPLICATIONS

The present invention claims priority under 35 U.S.C. § 119 to Japanese Patent Application No. 2020-191328, filed on Nov. 18, 2020, the entire content of which is incorporated herein by reference.

### BACKGROUND

### (1) Technical Field

The present disclosure relates to image forming devices, and in particular to techniques for suppressing an increase in toner consumption and a decrease in image quality due to an edge effect.

### (2) Description of the Related Art

Conventionally, an electrophotographic image forming device forms a toner image by electrostatically adsorbing toner on an electrostatic latent image formed on a photosensitive surface. Taking the case of using negatively charged toner as an example, an electrostatic latent image has an image area to which toner is attached by development and a non-image area to which toner is not attached. More toner attaching to an area of the image area close the edge of the non-image area than distant from the edge is known as an edge effect. When the edge effect occurs, more toner is consumed than necessary, and line width of line drawings and characters varies, causing deterioration of image quality.

As an example solution to this problem, a technique has been proposed for reducing toner consumption by making adjustments to pixel gradation according to distance from the edge, paying attention to the effect that the smaller the distance to the edge, the greater the edge effect and the larger the amount of toner adhered (see JP 2019-61284 A).

Further, the magnitude of the edge effect varies not only with distance from the edge to the pixel, but also with distance Ds from an outer circumferential surface of a developing roller to an outer circumferential surface of a photosensitive drum. Therefore, for example, a technique has been proposed in which the larger the distance Ds, the smaller an amount of toner adhered to a line end portion, referring to a design value of the distance Ds stored at the time of manufacturing the image forming device (see JP 2017-67897 A).

In order to optimize an amplitude Vpp of an AC component of developer bias due to variation in edge effect caused by the distance Ds, a technique has been proposed for measuring the density of a single pixel width line image with different gaps between lines in line images, and specifying the amplitude Vpp at which density of line images is stable even if the gaps vary between line images (see JP 2006-47852).

By adopting such conventional techniques, deterioration of image quality due to the edge effect can be suppressed.

Further, small sized characters may be rendered illegible if density is too high, and there is a risk of illegibility just from an increase in toner amount due to the edge effect. Regarding legibility of small sized characters, for example, a technique has been proposed for adjusting power of a laser beam that exposes the photosensitive surface to form an electrostatic latent image according to character size (see JP 2017-71146 A). By applying such a technique, it may be possible to improve legibility of small characters affected by the edge effect.

As described above, the degree of influence of the edge effect varies depending on the distance Ds from the outer circumferential surface of the developer roller to the outer circumferential surface of the photosensitive drum, and therefore if pixel gradation is uniformly corrected according to only distance from edges without regard to the distance Ds, a decrease in image quality cannot be sufficiently prevented.

On the other hand, if toner adhesion amount is uniformly corrected according to the distance Ds without regard to distance from edges, a decrease in image quality cannot be sufficiently prevented. Further, if only density of single pixel width line images is stabilized, then it is not possible to manage variation in influence of the edge effect according to distance from edges.

Further, when small sized characters are made illegible due to the edge effect, an amount of toner adhering varies depending on variation of influence of the edge effect, and therefore even if laser beam power is adjusted according to character size, legibility of illegible characters cannot be sufficiently improved.

Further, the influence of the edge effect varies not only according to distance from an edge to a pixel and the distance Ds, but also varies greatly according to environment, photosensitive film thickness, toner charge amount, photoreceptor sensitivity, overlap margin, developer bias conditions, and other conditions. Thus, even if image correction is performed focusing only on one condition, deterioration of image quality due to the edge effect cannot be sufficiently suppressed.

### SUMMARY

The present disclosure is made in view of the technical problems mentioned above, and an object of the present disclosure is to provide an image forming device capable of reducing unnecessary toner consumption due to the edge effect while preventing deterioration of image quality regardless of variation in the cause or degree of influence of the edge effect.

In order to achieve at least the above object, an image forming device reflecting an aspect of the present invention is an image forming device including a forming unit, an adhesion amount detector, a correction coefficient determiner, and a correction unit. The forming unit forms line images each having a different line width. The adhesion amount detector detects a toner adhesion amount for each of the line images. The correction coefficient determiner determines, according to the toner adhesion amounts detected for each line width, correction coefficients for a gradation value of the line images of each line width. The correction unit corrects a gradation value of a line image using a correction coefficient corresponding to the line width of the line image when forming the line image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the invention. In the drawings:

FIG. 1 illustrates the main structure of an image forming device 1 pertaining to at least one embodiment.

FIG. 2 illustrates the main structure of an imaging unit 100.

FIG. 3 is a block diagram illustrating the main structure of a controller 120.

FIG. 4 is a flowchart for describing gradation correction executed by the controller 120 according to the edge effect.

FIG. 5 is a diagram illustrating line images and a solid image formed for measuring actual changes in amount of toner adhering due to the edge effect.

FIG. 6A is a graph illustrating the principle of edge effect generation. FIG. 6B illustrates variation in distribution of amount of toner adhering according to line width as a feature of the edge effect.

FIG. 7 is a graph illustrating influence width and amount of the edge effect by illustrating a correspondence between line image dots and toner adhesion amount.

FIG. 8A is a table illustrating a correspondence between line width range and gradation correction coefficient. FIG. 8B is a table illustrating a correspondence between character size (points) range and gradation correction coefficient.

FIG. 9A is a graph illustrating a correspondence between line image dots and line width. FIG. 9B is a graph illustrating a correspondence between size of a Mincho font (points) and line width. FIG. 9C is a table illustrating a correspondence between line width and gradation correlation coefficient. FIG. 9D is a graph illustrating a correspondence between size of a Mincho font (points) and gradation correlation coefficient.

FIG. 10 is a graph illustrating changes in correspondence between line image dots and adhesion amount ratios when the edge effect varies.

### DETAILED DESCRIPTION

Hereinafter, one or more embodiments of the present invention will be described with reference to the drawings. However, the scope of the invention is not limited to the disclosed embodiments.

### [1] Structure of Image Forming Device

First, structure of an image forming device pertaining to an embodiment is described below.

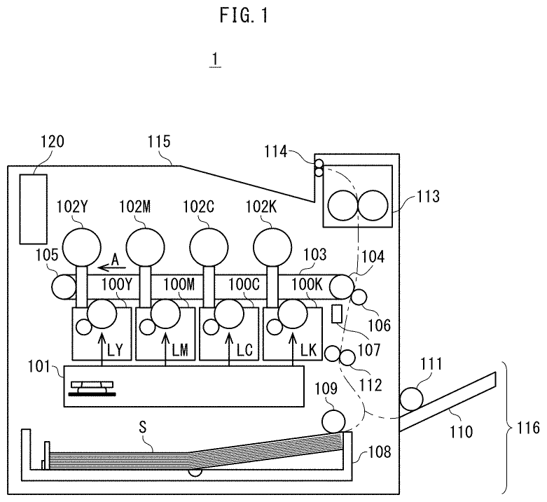

As illustrated in FIG. 1, an image forming device 1 is a tandem-type color printer that includes imaging units 100Y, 100M, 100C, and 100K that form toner images in yellow (Y), magenta (M), cyan (C), and black (K) colors, respectively. Toner cartridges 102Y, 102M, 102C, and 102K each containing a developer including a corresponding color of toner are detachably attached to the image forming device 1.

The imaging units 100Y, 100M, 100C, and 100K each receive supply of two-component developer from a corresponding one of the toner cartridges 102Y, 102M, 102C, 102K to form a toner image. The imaging units 100Y, 100M, 100C, and 100K have a common structure, and the toner cartridges 102Y, 102M, 102C, and 100K have a common structure, and therefore the following description is of a representative imaging unit 100 and toner cartridge 102, omitting the YMCK toner color designators.

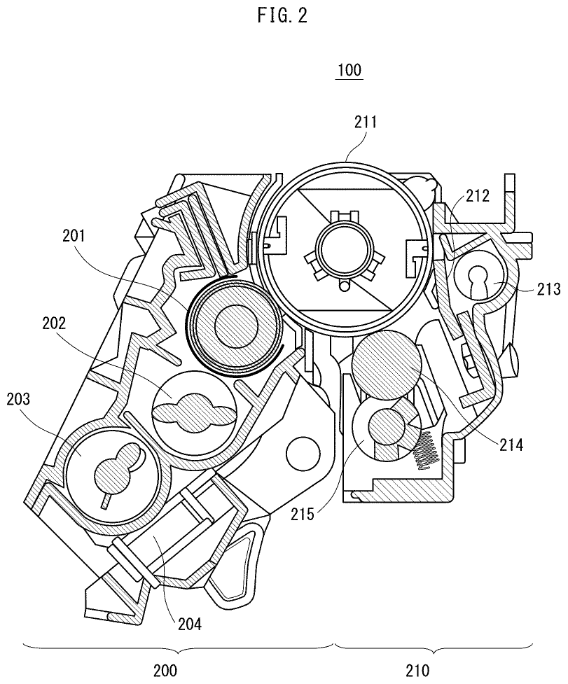

As illustrated in FIG. 2, the imaging unit 100 includes a photosensitive unit 210 and a developer unit 200. The photosensitive unit 210 includes a photosensitive drum 211, a cleaning blade 212, a charging roller 214, and the like. The photosensitive drum 211 has a cylindrical shape and includes a photosensitive layer that is photoconductive and a protective layer laminated on and protecting the photosensitive layer.

A charging roller 214 applies a charging bias to uniformly charge an outer cylindrical surface of the photosensitive drum 211. As a result, potential of the outer circumferential surface of the photosensitive drum 211 becomes V0 (according to at least one embodiment, −500 V). The cleaning roller 215 removes debris particles such as waste toner adhering to the charging roller 214. A charging device that uniformly charges the outer circumferential surface of the photosensitive drum 211 is of course not limited to the charging roller 214, and the outer circumferential surface of the photosensitive drum 211 may be uniformly charged by a charging device other than the charging roller 214.

An exposure unit 101 (FIG. 1) irradiates the outer circumferential surface of the photosensitive drum 211 with a laser beam modulated according to image data used for image formation, in order to form an electrostatic latent image. Areas of the outer circumferential surface of the photosensitive drum 211 irradiated by the laser beam (image area) conducts and loses charge. As a result, potential of the image area becomes Vi (according to at least one embodiment, −100 V).

The developer unit 200 uses a mixing developing method using a two-component developer, and includes a developer sleeve 201, a supply screw 202, a stirring screw 203, and a toner density sensor 204. The toner density sensor 204 detects a ratio of toner to carrier in the two-component developer stirred by the stirring screw 203. As a result of this detection, when it is confirmed that toner concentration is low, developer is replenished from the toner cartridge 102.

As a result, toner density of developer stored in the developer unit 200 is kept constant. The supply screw 202 and the stirring screw 203 cause developer supplied from the toner cartridge 102 to be triboelectrically charged by circulation and transport while being stirred in a developer tank. As a result, toner is negatively charged.

The developer sleeve 201 has a magnet roll on the exterior. A magnetic field generated by the magnet roll magnetically attracts the carrier in the developer onto an outer circumferential surface of the developer sleeve 201 to form a magnetic brush. The magnetic brush is transported to a developing area facing the photosensitive drum 211 by rotation of the developer sleeve 201, and supplies toner to an electrostatic latent image to visualize the electrostatic latent image.

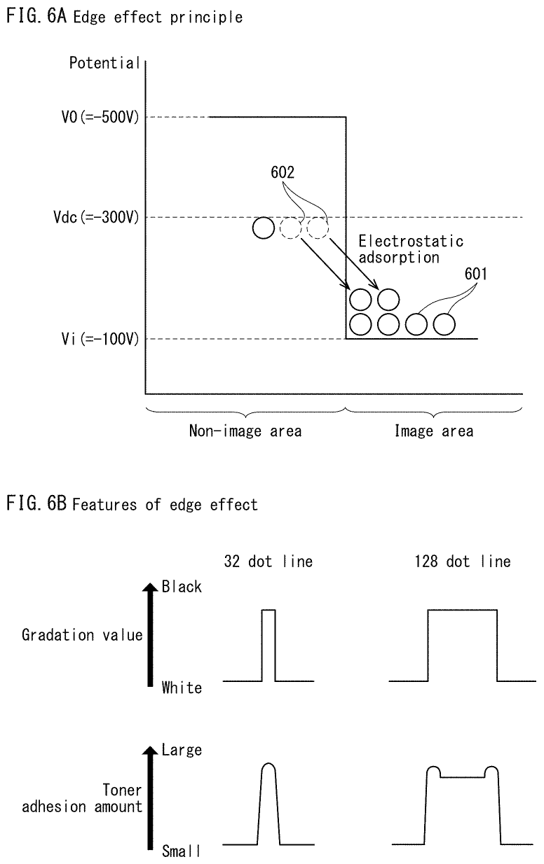

According to at least one embodiment, −300 V is applied as a developer bias Vdc, and according to an electric field generated by this developer bias Vdc (potential difference Δ=Vi−Vdc=200 V), as illustrated in FIG. 6A, negatively charged toner 601 moves to an image area (Vi=−100 V) on the outer circumferential surface of the photosensitive drum 211. From non-image areas, toner 602 in the vicinity of a boundary (edge) between an image area and a non-image area also moves to the image area due to a repulsive force with the non-image area and an electric field generated by developer bias Vdc (potential difference Δ=V0−Vdc=−200 V).

Therefore, an amount of toner that adheres near an edge of an image area is increased. This causes the edge effect. In an image area, the farther from an edge, the smaller the edge effect. As illustrated in FIG. 6B, in a line image having a line width of 32 dots, an amount of toner adhering increases due to the edge effect over the entire line width.

On the other hand, in a line image having a line width of 128 dots, a central portion of the line width is not affected by the edge effect and there is a portion where an amount of toner adhering does not increase. Therefore, when an average value of density is obtained for all pixels constituting a line image, an average value of density of a line image having a 32 dot line width is higher than that of a line image having a 128 dot line width.

In this way, a toner image formed on the outer circumferential surface of the photosensitive drum 211 is transported to a position corresponding to a primary transfer roller (not shown) by rotation of the photosensitive drum 211, and electrostatically transferred onto an outer circumferential surface of an intermediate transfer belt 103 (primary transfer). Toner remaining on the outer circumferential surface of the photosensitive drum 211 after the primary transfer is scraped off by a cleaning blade 212 then transported to and collected in a waste toner box (not shown) by a waste toner screw 213.

The intermediate transfer belt 103 is kept taut by a driving roller 104 and a driven roller 105, and travels in the direction of an arrow A in FIG. 1. Toner images of colors YMCK formed by the imaging units 100Y, 100M, 100C, and 100K are transferred at timings so as to overlap each other, forming a color toner image. In the case of forming a monochrome image, a toner image of any one of YMCK is formed.

The driving roller 104 is pressed against a secondary transfer roller 106 with the intermediate transfer belt 103 sandwiched in between, forming a secondary transfer nip. The intermediate transfer belt 103 transports a toner image to the secondary transfer nip.

In parallel with transport of a toner image by the intermediate transfer belt 103, a sheet is supplied from a sheet feed unit 116. The sheet feed unit 116 includes a sheet feed tray 108, a sheet feed roller 109, a manual feed tray 110, and a manual feed roller 111. A sheet stack is stored in the sheet feed tray 108. When supplying a sheet S from the sheet feed tray 108, the sheet feed roller 109 feeds a topmost sheet S of the sheet stack housed in the sheet feed tray 108 to a sheet transport path.

Further, when a sheet S is supplied from a sheet stack placed on the manual feed tray 110, the manual feed roller 111 feeds a topmost sheet S of the sheet stack stacked on the manual feed tray 110 to a sheet transport path. A sheet fed to the sheet transport path is transported to the secondary transfer nip. Whether a sheet S is supplied from the sheet feed tray 108 or the manual feed tray 110 depends on a user specification in an image forming job (print job).

A timing roller 112 adjusts transport timing of a sheet S so it reaches the secondary transfer nip in accordance with the timing at which a toner image transported by the intermediate transfer belt 103 reaches the secondary transfer nip. The timing roller 112 also corrects skew of the sheet S by pushing the sheet S against the stopped timing roller 112 until the sheet S bends a defined amount.

A secondary transfer bias is applied to the secondary transfer roller 106. At the secondary transfer nip, a toner image is electrostatically transferred from the intermediate transfer belt 103 to a sheet S by the secondary transfer bias (secondary transfer). Toner remaining on the intermediate transfer belt 103 after the secondary transfer is collected by a cleaning device (not shown) and discarded. Meanwhile, the sheet S is transported to a fixing unit 113.

The fixing unit 113 heat fixes a toner image carried on the sheet S to the sheet S. The sheet S on which the toner image is heat fixed is ejected onto a paper ejection tray 115 by a paper ejection roller 114.

When a controller 120 receives an image forming job for a user of the image forming device 1, the controller 120 monitors and controls operation of the image forming device 1 to execute the image forming job.

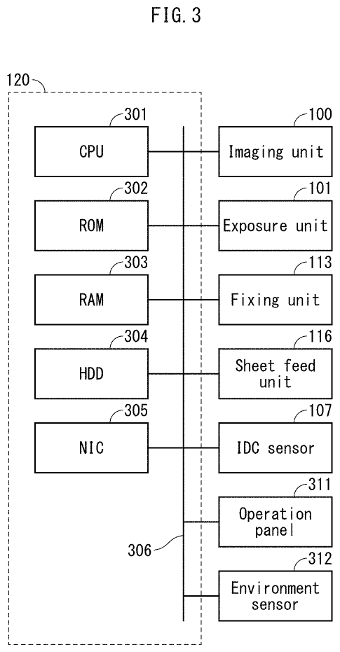

As illustrated in FIG. 3, the controller 120 has a structure in which a central processing unit (CPU) 301, a read only memory (ROM) 302, a random access memory (RAM) 303, and the like are connected by an internal bus 306. When the CPU 301 is reset by turning on power to the image forming device 1, a boot program is read from the ROM 302 and executed, and using the RAM 303 as working storage, an operating system (OS), control program, image processing program, etc., are read from a hard disk drive (HDD) 304 and executed.

A network interface card (NIC) 305 executes processing for communicating with other devices via a communication network such as a local area network (LAN) or the Internet. As a result, the controller 120 receives an image forming job from another device. An operation panel 311 is connected to the controller 120, and an image forming job can be accepted via a user of the image forming device 1 operating the operation panel 311.

The controller controls and monitors operations of the imaging unit 100, the exposure unit 101, the fixing unit 113, and the sheet feed unit 116 when executing an image forming job. An image density control (IDC) sensor 107 (FIG. 1), which is a reflective optical sensor, is disposed between the primary transfer position of the imaging unit 100K and the fixing nip in the travel direction of the intermediate transfer belt 103, and detects gradation of a toner image carried on the outer circumferential surface of the intermediate transfer belt 103. The controller 120 can use the IDC sensor 107 to detect a change in toner adhesion amount due to the edge effect by detecting toner adhesion amount of a pattern described later.

Further, an environment sensor 312 is disposed inside the image forming device 1 to detect environment temperature and humidity. The controller 120 detects changes in environment temperature and humidity in the device by referencing detection signals of the environment sensor 312. The influence of the edge effect changes to some extent with temperature, but is especially affected by environment humidity. Therefore, by monitoring environment humidity, the controller 120 can appropriately determine timing re-detecting a change in toner adhesion amount due to the edge effect.

### [2] Gradation Correction Processing by Controller 120

When an amount of toner adhered due to the edge effect varies as described above, line image and character image gradation varies, for example in a color image, image quality can deteriorate due to color tint variation and the like. In response to this problem, according to at least one embodiment, a variation in toner adhesion amount is actually detected, and gradation of line images and characters is corrected according to detected variation, thereby preventing deterioration in image quality.

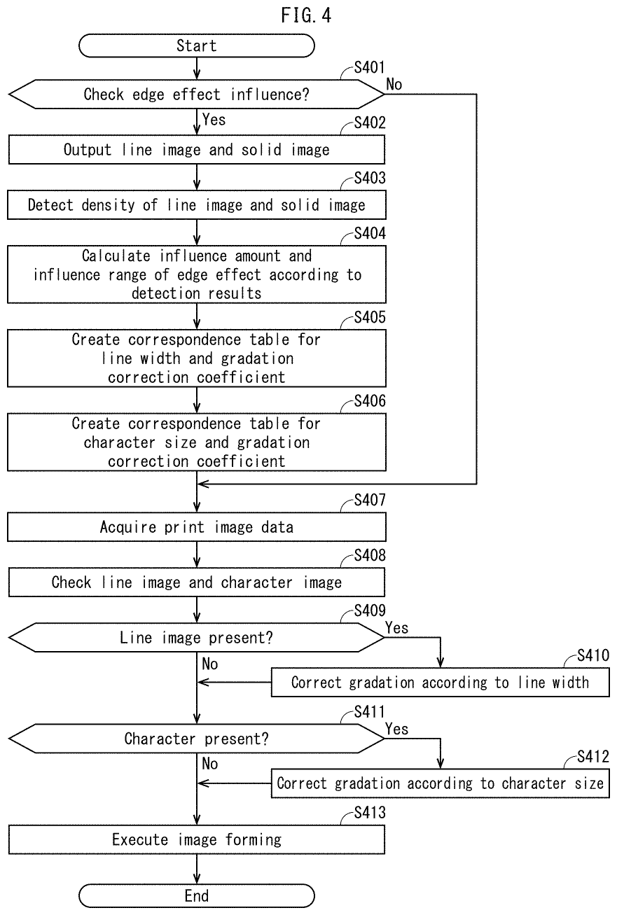

Therefore, as illustrated in FIG. 4, the controller 120 first determines whether or not edge effect influence should be checked. When edge effect influence changes, gradation cannot be appropriately corrected unless a method of line image and/or character gradation correction is changed.

Whether or not there is a possibility that edge effect influence has changed may be determined, for example, by determining whether or not a consumable or device part has been replaced. Here, “device part” may include a photosensitive part. If a consumable or part has been replaced, it can be determined there is a possibility that edge effect influence has changed. As an example, if the developer unit 200 or the photosensitive unit 201 is replaced, the distance Ds from the developer sleeve 201 to the outer circumferential surface of the photosensitive drum 211 may change, and therefore it is determined that there is a possibility that the edge effect influence has changed.

Further, whether there is a possibility that edge effect influence changed can be determined by using the environment sensor 312 to detect environment conditions, and when the edge effect influence is checked, determining whether environment conditions have changed by an amount exceeding a defined range. To give a specific example, a change in environment humidity is a change in environment condition that can cause a change in toner charging performance, and therefore such a change can be determined as an indicator that edge effect influence may have changed.

Whether or not environment humidity has changed is determined by setting an environment humidity range in advance, according to toner charging properties, and detecting environment humidity each time a check for the possibility of a change in edge effect influence is performed. From the detected environment humidity, if environment humidity varies beyond the environment humidity range set, it may be judged that there is a possibility that environment humidity has changed to an extent that changes edge effect influence.

Further, when photosensitive film thickness, toner charge amount, photosensitivity, or the like change beyond a defined range when compared to the last time edge effect influence was checked, then it may be determined that there is a possibility that edge effect influence has changed, as a result of reaching a defined state of wear and aging. As an example, when film thickness of the photosensitive layer of the photosensitive drum 211 changes, charging properties of the outer circumferential surface of the photosensitive drum 211 change.

The photosensitive layer wears down in proportion to the number of images formed and therefore, for example, it may be determined that each time a cumulative value of number of images formed reaches a defined number, film thickness of the photosensitive layer has changed to an extent that changes the edge effect influence.

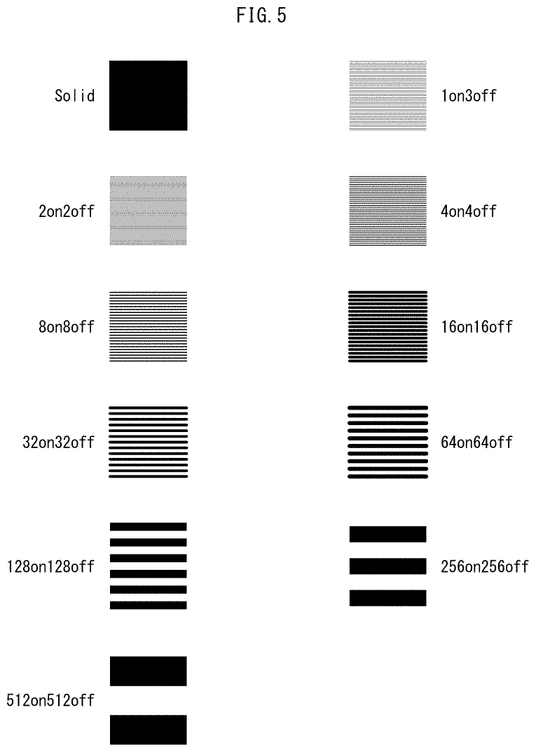

If it is determined that edge effect influence is to be checked (“Yes” in S401), a line image and solid image are output (S402). According to at least one embodiment, as illustrated in FIG. 5, a solid image, a stripe image alternating 1 dot width lines with 3 dot width spaces, and stripe images alternating line dot widths and spaces for different powers of 2 dots are output.

Line spacing of a line image with a line width of 1 dot (2 to the 0th power) is set to have 3 dot gaps because a change in density due to the edge effect is clarified when the edge effect can cause a sufficient amount of toner to move from the white background to the line image. When line spacing is only 1 dot, areas corresponding to white background on the developer sleeve become narrow, and therefore an amount of toner moving to line image areas decreases, and there is a risk that a change in density due to the effect is not clear.

There are nine powers of 2 illustrated, from 2 to the 1st power (=2) to 2 to the 9th power (=512). In FIG. 5, 2on2off to 512on512off correspond to the nine powers. The solid image may be any image that can be used to detect an amount of toner adhering when not affected by the edge effect. For example, the solid image may be a line image having a defined line width that is not affected by the edge effect.

These images are formed for each color YMCK and are transferred to different location on the outer circumferential surface of the intermediate transfer belt 103. When a degree of edge effect differs depending on toner color, such as when ease of charging differs, it is effective to measure toner adhesion amounts separately for each toner color. On the contrary, when there is little difference in edge effect between toner colors, one color only, such as K, may be used.

Further, if a longitudinal direction of the line images is orthogonal to the travel direction of the intermediate transfer belt 103, detected values may change depending on reading timing by the IDC sensor 107, especially in a line image having a wide line width. On the other hand, if the longitudinal direction of the line images is parallel to the travel direction of the intermediate transfer belt 103, appearance of the line images does not change regardless of the reading timing by the IDC sensor 107, so that detected values are stable.

Next, the IDC sensor 107 is used to detect an amount of toner adhering to line images and solid images (also referred to as “toner detection amount”) (S403), and an amount and range of edge effect influence are calculated from the toner detection amount (S404). Therefore, for line images, the toner adhesion amount per unit area in a line image portion (exposure area) is calculated from the toner detection amount.

In the solid image, the entire area is the exposure area, and therefore the toner adhesion amount detected by the IDC sensor 107 is the toner adhesion amount per unit area. For line images, the IDC sensor 107 outputs a toner detection amount reflecting a line image portion (exposure area) and a white background portion without the line image (non-exposure area), and therefore the toner adhesion amount is calculated using an area ratio (BW ratio) of the line image portion to the white background portion.

For example, in the 1on3off line image, an area of the line image portion is a quarter of the total area, and therefore the toner adhesion amount is obtained by multiplying the toner detection amount according to the IDC sensor 107 by four. On the other hand, in the 2on2off, 4on4off, etc., line images, an area of the line image portion is half of the total area, and therefore the toner adhesion amount is double the toner detection amount according to the IDC sensor 107.

Using the toner adhesion amount calculated in this way, a ratio of line image toner adhesion amount to solid image toner adhesion amount (adhesion amount ratio) is obtained.

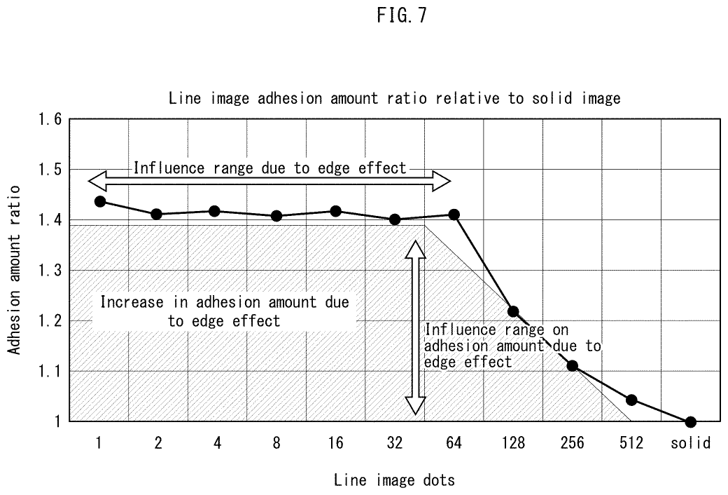

FIG. 7 is a graph plotting adhesion amount ratio for each line width, with line image line width (line image dots) as the horizontal axis (a logarithmic axis), and adhesion amount ratio as the vertical axis. The adhesion amount ratio when the line width is “solid” is the adhesion amount ratio of a solid image, and the value is of course 1. The solid image is used as a reference for being unaffected by the edge effect, and the area of the solid image (line width) is predefined. As illustrated in FIG. 6B, when line width is small, the edge effect acts on all pixels of the line image and the toner adhesion amount increases.

On the other hand, when line width exceeds a certain value, the edge effect does not act on a central portion farthest from edges of the line image, and therefore density toner at pixels in the central portion does not increase. Therefore, when line width exceeds a certain value, the larger the line width, the lower the adhesion amount ratio. In the example of FIG. 7, when line width is 64 dots or less, the adhesion amount ratio is constant at about 1.4, and when line width exceeds 64 dots, the adhesion amount ratio decreases almost linearly.

Therefore, a range of line width in which the edge effect can affect the entire line image is called an edge effect influence range, and the adhesion amount ratio is also referred to as an influence amount. In the example of FIG. 7, when line width exceeds 64 dots, the influence amount gradually decreases, and therefore the edge effect influence range is from 1 dot to 64 dots. The influence amount is 1.4 when the line width is 32 dots, and 1.1 when the line width is 256 dots.

According to at least one embodiment, the reciprocal of the adhesion amount ratio is used as a correction coefficient of a gradation value of line images of corresponding line width (also referred to as “gradation correction coefficient”). That is, regarding an increase in toner adhesion amount by the adhesion amount ratio due to the edge effect, if the gradation value is multiplied in advance by the gradation correction coefficient that is the reciprocal of the adhesion amount ratio, then a gradation value of a line image actually formed by developing can be made the same as a gradation value of solid image unaffected by the edge effect.

$$( Actual gradation value ) = ( image data gradation value ) \times ( gradation correction coefficient ) \times ( adhesion amount ratio ) = ( image data gradation value ) \times {( adhesion amount ratio )}^{- 1} \times ( adhesion amount ratio ) = ( image data gradation value ) \qquad Expression ( 1 )$$

Accordingly, actual gradation value and image data gradation value can be made to match. However, adhesion amount ratio is calculated based on toner adhesion amount per unit area, and therefore the “actual gradation value” and “image data gradation value” of Expression (1) are equivalent in meaning to an average value of gradation of the line image.

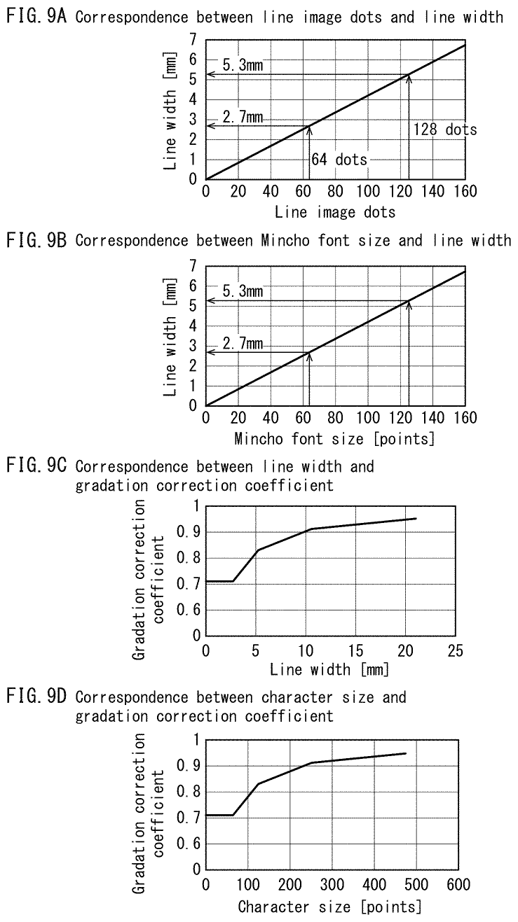

By performing such a calculation, a correspondence table can be created for correspondence between line width and gradation correction coefficient, as illustrated in FIG. 9A (S405). An image formed by the image forming device 1 pertaining to at least one embodiment has a resolution of 600 dots per inch (dpi), and a line width of 1 dot corresponds to 42 μm (1 inch/600 dots). For example, to find a gradation correction coefficient when line width is 1 mm or less, see Expression (2) below.

(1 mm)/(42 μm)≈(24 dots) Expression (2)

24 dots is within the influence range in the graph of FIG. 7, and the reciprocal of the adhesion amount ratio within the influence range is the value of the gradation correction coefficient.

(Gradation correction coefficient)=1/1.4≈0.71 Expression (3)

As another example, to find a gradation correction coefficient when line width is from 6 mm to 7 mm, see Expressions (4) and (5) below.

(6 mm)/(42 μm)≈(143 dots) Expression (4)

(7 mm)/(42 μm)≈(167 dots) Expression (5)

Referring to the graph of FIG. 7, in the range of line width from 64 dots to 512 dots, line width doubling approximately halves a value obtained by subtracting 1 from the adhesion amount ratio.

(Adhesion amount ratio)=[(1.4−1)×{(64 dots)/(line width)}]+1={0.4×(64 dots)/(line width)}+1 Expression (6)

This allows the adhesion amount ratio to be calculated approximately. The gradation correction coefficient is the reciprocal of the adhesion amount ratio.

(Gradation correction coefficient)=1/(adhesion amount ratio)=1/[{0.4×(64 dots)/(line width)}+1] Expression (7)

Substituting line width calculated by Expressions (4) and (5) into Expression (7):

(Gradation correction coefficient at 6 mm line width)≈0.85 Expression (8)

(Gradation correction coefficient at 7 mm line width)≈0.87 Expression (9)

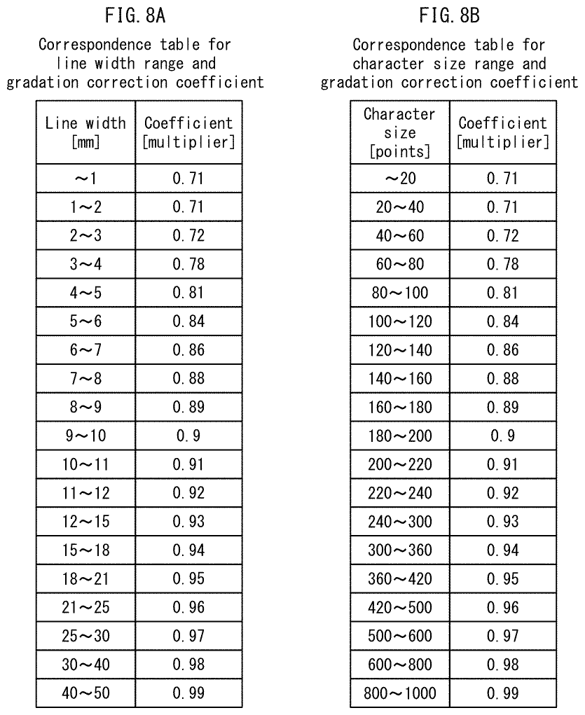

The average value from Expressions (8) and (9) is 0.86, and the values shown in the table of FIG. 8A can be obtained. The graph in FIG. 9C is a plot of the table in FIG. 8A. The narrower the line width, the greater the edge effect and the larger the adhesion amount ratio, so the value of the gradation correction coefficient is smaller.

Further, a correspondence table for correspondence between character size and gradation correction coefficient can be created, as illustrated in FIG. 8B (S406). The correspondence table for character size and gradation correction coefficient can be obtained from the correspondence table for line width and gradation correction coefficient by using correlation between line width and character size.

First, as illustrated in FIG. 9A, line image dots and line width have a proportional correspondence, and as shown by Expressions (4) and (5), line width corresponding to line image dots can be calculated. Next, as illustrated in FIG. 9B, the size of Mincho font characters (points) and line width also have a proportional correspondence. Here, line width is line width of a thick vertical line included in a Mincho font character. Accordingly, via the same line width, line image dots and Mincho font character size can be linked.

For example, as illustrated in FIG. 8B, when the size of a Mincho font character is from 180 points to 200 points, then extrapolating from the graph of FIG. 9B, line width is from 8.1 mm to 8.9 mm. This corresponds to a value from 0.89 to 0.9 when referring to the table in FIG. 8A, so a value of 0.9 is shown in the row corresponding to 180 points to 200 points in FIG. 8B.

By performing such a calculation for each character size range, a correspondence table for character size and gradation correction coefficient can be created. FIG. 9D is a graph plotting the values of the table in FIG. 8B. As illustrated in FIG. 9D, the smaller the character size, the narrower the line width corresponding to the character size, so the edge effect is greater and the toner adhesion ratio increases. Therefore, the smaller the character size, the smaller the value of the gradation correction coefficient, and the larger the character size, the smaller the edge effect, such that the gradation correction coefficient gradually approaches 1.

It should be noted that a character image includes lines having various line widths, and magnitude of the influence of the edge effect may vary in a complicated way according line width of each line. Further, even if character size is the same, if characters are different, the influence of the edge effect also changes. According to at least one embodiment, the gradation correction coefficient is uniformly determined with reference to the thickest line, and gradation correction does not necessarily strictly follow every change in magnitude of edge effect influence for each line of a character image.

However, from the viewpoint of visibility, the thickest straight line is most noticeable, and therefore if the edge effect influence on the thickest straight line can be corrected accurately, the edge effect influence can effectively be made less conspicuous. Further, gradation correction is also performed on straight lines other than the thickest straight line, and therefore the edge effect influence is made less noticeable on these straight lines as well.

After completing the processing of step S406, or when edge effect influence is not checked (“No” in S401), the controller 120 acquires print image data (S407). The print image data is specified in the image forming job. The image forming job may include text data to be printed as print image data. When text data is included as print image data, character size (points) is specified for each character.

Next, the controller 120 refers to print image data and checks whether a line image or character image is included for each toner color (S408). The edge effect is generated during development of an electrostatic latent image, and therefore for each toner color, and even if the edge effect is generated for one of the toner colors, the edge effect for that toner color has no effect on other toner colors.

If a line image is detected as a result of checking the print image data (“Yes” in step S409), the correspondence table for line width and gradation correction coefficient is referenced, gradation correction coefficient is specified according to line width of the line image, and gradation values of pixels included in the line image are corrected using the gradation correction coefficient (S410). Typically-used algorithms such as the Hough transform can be used to detect straight lines and curves.

Regarding line width, a removal process is executed in which pixels that form a line among pixels that form a straight line or curved line and that are also adjacent to other pixels are considered to be end pixels in a line width direction and are removed, and subsequently, if pixels that form a line remain, the removal process is repeated.

Then, line width can be specified from the number of times the removal process is repeated until the pixels that form the line are eliminated. For example, in the case of a straight line having a line width of 3 dots, pixels of an edge portion are removed by the first removal process, and line width becomes 1 dot.

Further, the second removal process is performed and pixels that form the line are eliminated. Accordingly, line width is determined to be 3 dots, and therefore:

(42 μm)×(3 dots)≈0.1 mm Expression (10)

0.71 is used as the gradation correction coefficient, which is the gradation correction coefficient when line width is 1 mm or less.

Next, if there is a character image (“Yes” in step S411), the gradation correction coefficient corresponding to the character size of the character image is specified by referring to the correspondence table for character size and gradation correction coefficient, and gradation value of the pixels forming the character image is corrected using the gradation correction coefficient (S412). When an image forming job specifies character size by the addition of character size specification to text data, the gradation of a character image may be corrected by referring to the correspondence table for character size and gradation correction coefficient and correcting based on the character size specified in the image forming job.

Further, a character image may be detected by image recognition processing. In such a case, character size can be detected at the same time as detection of a character image, and therefore if the correspondence table for character size and gradation correction coefficient is referenced, a gradation correction coefficient corresponding to a detected value of character size is specified, and the specified gradation correction coefficient is used, gradation correction can be effectively and appropriately executed.

Subsequently, image forming processing is executed using print image data with the corrected gradation value (S413), and processing ends.

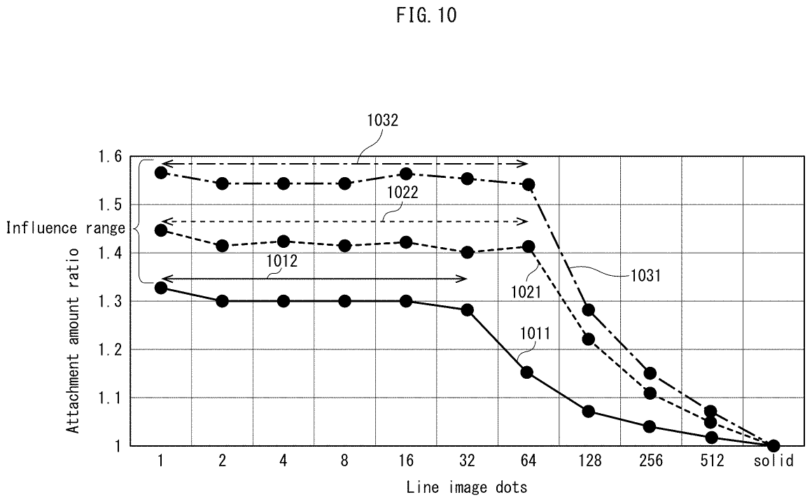

As described above, according to at least one embodiment, a degree of edge effect influence is actually measured to determine a gradation correction coefficient. For example, as illustrated in FIG. 10, adhesion amount ratios vary as illustrated by graphs 1011, 1021, and 1031, depending on changes in environment, photosensitive film thickness, Ds, toner charge, photoconductor sensitivity, noise margins, developer bias, and the like.

Graph 1011 shows adhesion amount ratios observed when a repulsive force between non-exposed areas and toner is small and the edge effect is reduced because environment humidity is low and toner charge is small. On the other hand, graph 1031 shows adhesion amount ratios observed when a repulsive force between non-exposed areas and toner is large and the edge effect is increased because environment humidity is high and toner charge is large.

Of course, if the edge effect decreases, the graph 1011 of adhesion amount ratio also decreases, and an influence range 1012 becomes narrower. In response to this, according to at least one embodiment, gradation correction coefficient values increase and approach 1. On the other hand, if the edge effect increases, the graph 1031 of adhesion amount ratio also increases, and an influence range 1032 becomes wider. In response to this, according to at least one embodiment, gradation correction coefficient values become smaller. The intermediate graph 1021 has an intermediate influence range 1022.

Therefore, even if a degree of edge effect influence changes due to a change in at least one of environment, photosensitive film thickness, Ds, toner charge, photoconductor sensitivity, noise margin, developer bias, or the like, a change in gradation value caused by the edge effect can be accurately corrected, and excellent image quality can be achieved. Further, even if the edge effect occurs, lowering a gradation value makes it possible to suppress an increase in toner adhering, making it possible to suppress unnecessary toner consumption.

### [3] Modifications

Although at least one embodiment has been described above, the present disclosure is of course not limited to an embodiment described above. The following modifications can be implemented.

(3-1) Although not specifically mentioned above, a solid image does not necessarily have to fill an entire image forming area, and it is sufficient to fill an area wider than a density detection area of the IDC sensor 107, to an extent that the edge effect does not occur in an area detected by the IDC sensor 107.

Further, among pixels for which density is detected by the IDC sensor 107, as long as the edge effect does not occur for a pixel for which detected density is referenced in calculating adhesion amount ratio, then as long as an area larger than the density detection area of the IDC sensor is filled, the toner adhesion ratio can be calculated accurately.

The smaller the area to be filled as a solid image, the smaller the amount of toner required to fill the area, which is useful in reducing toner consumption.

(3-2) According to at least one embodiment, toner adhesion amounts are measured for line images having line widths that are powers of 2, but the present disclosure is of course not limited to this. Amount of toner adhering may be measured using line images having equal widths, or line image having different widths.

Further, when a variation range for influence range is specified in advance, a toner adhesion amount may be measured for a line image that has a line width that can be at an end of the influence width and a solid image, and line images that have line widths that fall within the influence width may be assumed to have the same toner adhesion amount as the measured line image.

Further, for line images from the measured line image to the solid image, toner adhesion amounts may be estimated by interpolation from toner adhesion amounts of the measured line image and the solid image, based on proportional distribution according to line width. In this way, toner consumption can be reduced by reducing the number of line images for which toner adhesion amount is actually measured.

Further, toner adhesion amount of the solid image may be estimated by extrapolation using the toner adhesion amount for a line image having a line width equal to or larger than the influence range. In this way, toner consumption can be reduced by making it unnecessary to form a solid image that consumes more toner than a line image.

For example, when using a line image such as 2on2off or 4on4off as described above, even considering an increase in toner consumption due to the edge effect, a solid image uses nearly twice as much toner as a line image. Accordingly, if forming a solid image is not necessary, nearly twice as much toner as that required for a line image can be saved.

(3-3) According to at least one embodiment, the line images are striped images consisting of straight lines, but the present disclosure is of course not limited to this, and a curved line may be used instead of a straight line. Further, the number of lines is arbitrary and the number of lines may even be one. Further, gradation correction coefficient may be calculated by detecting an amount of toner adhering to a line image having a line width of 1 dot or less.

Further, aside from a line image, for example circular images (filled circles) having various radii may be used, and by comparing toner adhesion amounts with that of a solid image, it is possible to calculate the influence range and toner adhesion ratios due to the edge effect, and obtain gradation correction coefficients. As described above, regardless of an image formed to obtain a toner adhesion ratio, as long as the technique of the present disclosure is adopted, the same effect as that described for an embodiment above can be obtained.

(3-4) According to at least one embodiment, toner adhesion amount is actually measured for a line image or solid image carried on the intermediate transfer belt 103, but the present disclosure is not limited to this.

For example, a toner adhesion amount may be measured while a line image or solid image is carried on the photosensitive drum 211. In this case, after an electrostatic latent image is developed, before the cleaning blade 212 is reached and preferably at a position between a developer position and the primary transfer position along a circumferential direction of the photosensitive drum 211, it is necessary to provide the IDC sensor 107 facing the outer circumferential surface of the photosensitive drum 211.

Further, toner adhesion amount may be measured where a line image or solid image is transferred to a sheet S. In this case, it is of course necessary to provide the IDC sensor 107 downstream of the secondary transfer position where the toner image is transferred to a sheet S. If such a structure is adopted, the present disclosure can be applied to the image forming device 1 that uses a print method other than an intermediate transfer method.

Further, a sensor other than the IDC sensor 107 may be used. For example, after transfer to the sheet S, the toner adhesion amount may be measured using a scanner. Even if thin lines are made less legible by heat fixing, a toner adhesion amount itself is maintained, and can therefore be measured.

(3-5) According to at least one embodiment, the size of characters is specified as the size of Mincho font character, but the present disclosure is of course not limited to this. Correspondence tables may be created for each fonts other than Mincho.

For example, correspondence between character size (points) and line width as illustrated in FIG. 9B can be determined in advance for each font, and based on this correspondence, correspondence tables for character size and gradation correction coefficient can be made for each font from the correspondence between line width and gradation correction coefficient.

Further, for fonts having a common correspondence between character size (points) and line width as illustrated in FIG. 9B, if the same correspondence table is shared, the number of correspondence tables to be prepared in advance can be reduced. Therefore, processing load and processing time for creating correspondence tables, storage for storing correspondence tables, and the like can be reduced.

Further, according to at least one embodiment, as illustrated in FIG. 9A and FIG. 9B, line image dots and character size (points) are linked via line width, but the present disclosure is of course not limited to this. A table directly linking line image dots and character size (points) may be prepared, or conversion may be performed by a calculated function.

(3-6) According to at least one embodiment, gradation correction coefficient is calculated prior to execution of image forming processing. Considering the object of reducing toner consumption, then as described, it is appropriate that only when image forming processing is to be executed is a toner adhesion amount of a line image or solid image detected, and gradation coefficient calculated, but the present disclosure is of course not limited to this.

When gradation correction coefficient is calculated prior to execution of image forming processing, there is a risk of image forming processing start timing being delayed, and first copy output time (FCOT) becoming longer. FCOT is one index value indicating performance of the image forming device 1. In this sense, it is effective to execute line image and solid image toner adhesion amount processing and gradation correction coefficient calculation processing when image forming processing is not being executed, such as after image forming processing is executed.

(3-7) According to at least one embodiment, the image forming device 1 is described as a tandem-type color printer, but the present disclosure is of course not limited to this example. A color printer other than a tandem-type may be used. A monochrome printer may be used. Further, the image forming device 1 may be a copy device having a scanning function, a facsimile machine having a facsimile function, or a multi-function peripheral (MFP) having such functions.

Further, according to at least one embodiment, two-component developer composed of toner and a carrier is used, but the present disclosure is of course not limited to this example. A single-component developer composed only of toner may be used. In either case, similar effects can be obtained by application of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming device, comprising:
a forming unit that forms line images each having a different line width;
an adhesion amount detector that detects a toner adhesion amount for each of the line images;
a correction coefficient determiner that determines, according to the toner adhesion amounts detected for each line width, correction coefficients for a gradation value of the line images of each line width; and
a correction unit that corrects a gradation value of a line image using a correction coefficient corresponding to the line width of the line image when forming the line image.

2. The image forming device of claim 1, wherein each of the line images, which each have a different line width, are affected to a different extent by an edge effect.

3. The image forming device of claim 1, wherein the correction coefficients are determined so that, for each line image, the toner adhesion amount of the line image formed with a corrected gradation value becomes a toner adhesion amount corresponding to the gradation value before correction, due to an edge effect.

4. The image forming device of claim 3, wherein
the forming unit further forms a solid image having a line width defined to not be affected by the edge effect,
the adhesion amount detector further detects a toner adhesion amount of the solid image, and
each of the correction coefficients is a ratio of the toner adhesion amount of the solid image to the toner adhesion amount of one of the line widths.

5. The image forming device of claim 1, wherein
the correction coefficient determiner further determines character image gradation value correction coefficients by using the correction coefficients of the line images of line widths corresponding to character sizes of character images, and
the correction unit further corrects a gradation value of a character image using a correction coefficient corresponding to the character image when forming the character image.

6. The image forming device of claim 5, wherein the correction coefficient determiner associates a line width of a thickest vertical line in a Mincho font character image with a character size of the Mincho font character image.

7. The image forming device of claim 5, wherein
the correction coefficient determiner
has a storage for storing correspondence between line widths of line images and character sizes of character images, and
determines the character image gradation value correction coefficients according to the correspondence stored in the storage.

8. The image forming device of claim 1, wherein
each of the line images is a striped image in which lines are arranged at equal intervals, and
the adhesion amount detector detects toner adhesion amounts of the striped images.

9. The image forming device of claim 1, wherein the different line widths of the line images exponentially increment in line width, where the line widths are powers having a common base and different exponents.

10. The image forming device of claim 1, wherein the different line widths of the line images linearly increment in line width.

11. The image forming device of claim 1, wherein the line images include line images having line widths of 1 dot or less.

12. The image forming device of claim 1, further comprising:
a replacement determiner that determines whether a consumable or part has been replaced, wherein
upon determination that a consumable or part has been replaced, the forming unit forms the line images, the adhesion detector detects the toner adhesion amounts, and the correction coefficient determiner determines the correction coefficients.

13. The image forming device of claim 1, further comprising:
a lifespan determiner that determines whether the image forming device has reached a specified lifespan state, wherein
upon determination that the specified lifespan state has been reached, the forming unit forms the line images, the adhesion detector detects the toner adhesion amounts, and the correction coefficient determiner determines the correction coefficients.

14. The image forming device of claim 1, further comprising:
an environment determiner that determines whether an environment condition has changed, wherein
upon determination that the environment condition has changed, the image forming unit forms the line images, the adhesion detector detects the toner adhesion amounts, and the correction coefficient determiner determines the correction coefficients.
